(19) United States
(12) Patent Application Publication
(10) Pub. No.: US 2018/0342836 A1
(43) Pub. Date: Nov. 29, 2018

(54) Electric Outlet Wall Plate Tether

(71) Applicant: Jared Mancil, Boca Raton, FL (US)

(72) Inventor: Jared Mancil, Boca Raton, FL (US)

(21) Appl. No.: 15/605,800

(22) Filed: May 25, 2017

(51) Int. Cl. H01R 13/639; H01R 13/58

(52) U.S. Cl. CPC H01R 13/6395; H01R 13/5812

(57) ABSTRACT

The current invention are tethers that secure an electric plug into an electric outlet wall plate. The tether is secured to the wall plate by the screw that secures the wall plate to the wall. The tether is secured to the electric cord by a loop that fastens around the cord. The tether is too short for the electric cord to be unplugged while secured. Designed with the safety of young children in mind, this device can also be useful in preventing the accidental remove of cords, which can be valuable in protecting some types of electronics.

### CROSS-REFERENCES TO RELATED APPLICATIONS (IF ANY)

None.

### BACKGROUND

### 1. Field of the Invention

This invention relates to electrical safety equipment and particularly to equipment that reduces risks of cords being removed from the outlet preventing other dangerous items from being placed in the electric outlets.

### 2. Description of Prior Art

While childhood electrocution deaths and injuries are rare, the majority of these events are in an home and due to either faulty equipment or a child not understanding the risks (https://www.ncbi.nlm.nih.gov/pubmed/12542812). Risks can include electricity exposed to wet surfaces, exposed wires, faulty appliances, and exposed electrical outlets. Technology improves regularly to increase safety. Household examples include ground fault circuit interrupters that shut off electric when flowing incorrectly and plastic outlet inserts to reduce accidental exposure.

There is still room for improvement in the art.

### SUMMARY OF THE INVENTION

The current invention are electric outlet accessories that secures electric cords to the outlet. This reduces the chances of an infant or toddler removing or tampering with electric cords in wall outlets.

The invention would be a strong, flexible material that is used as a tether between an electric outlet wall plate and an electric cord.

One end of the tether would secure to the electric outlet wall plate. The tether would be secured by the screw that holds the wall plate to the wall.

When an electric cord is plugged in the outlet, the other end of the tether would latch around the electric cord. This end of the tether would form a ring with an opening, which can be latched to prevent young children opening it.

The tether would be of a length that has too little slack to allow the electric cord to be unplugged, while the tether is secured on both ends.

### BRIEF DESCRIPTION OF THE DRAWINGS

Without restricting the full scope of this invention, the preferred form of this invention is illustrated in the following drawings:

FIG. 1 shows the cord tether in use;

FIG. 2 shows the cord tether in use from the side;

FIG. 3 shows the cord tether in use from the front;

FIG. 4 shows the cord tether from the side;

FIG. 5 shows the cord tether from the side;

FIG. 6 shows a front view of the cord tether; and

FIG. 7 shows a back view of the cord tether.

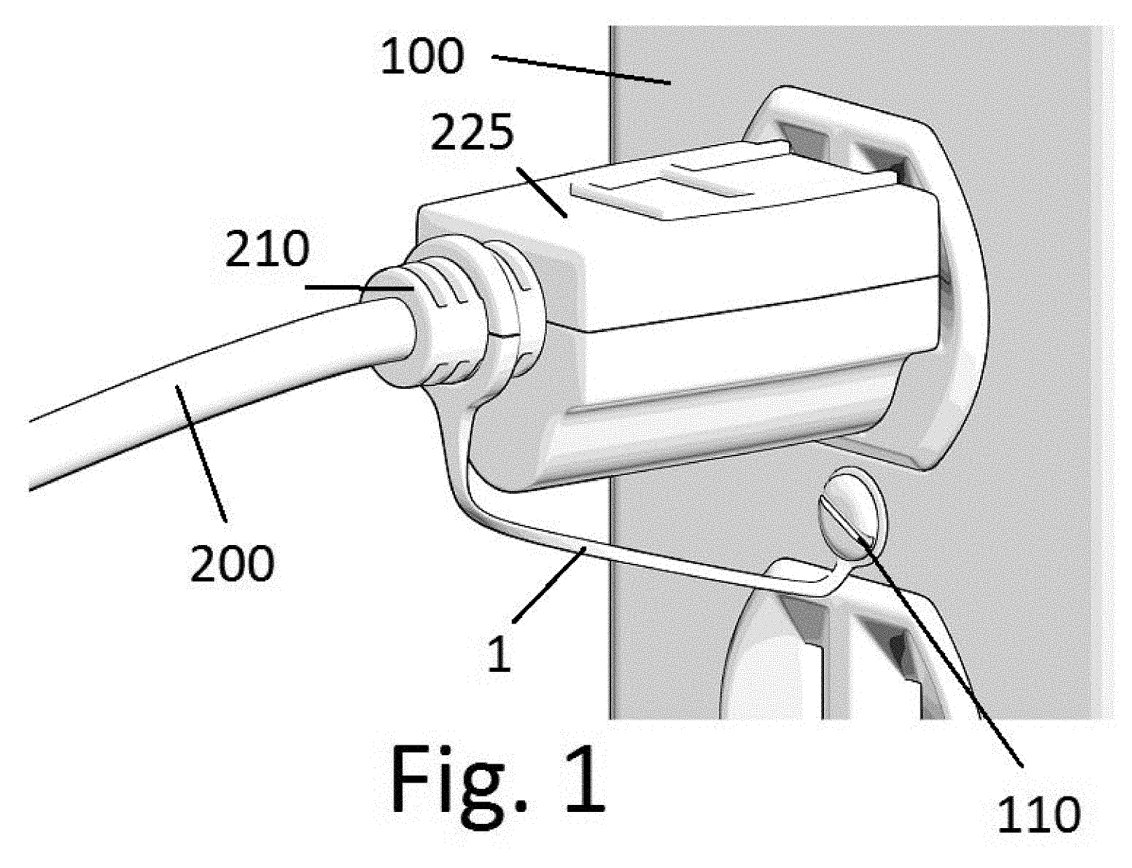

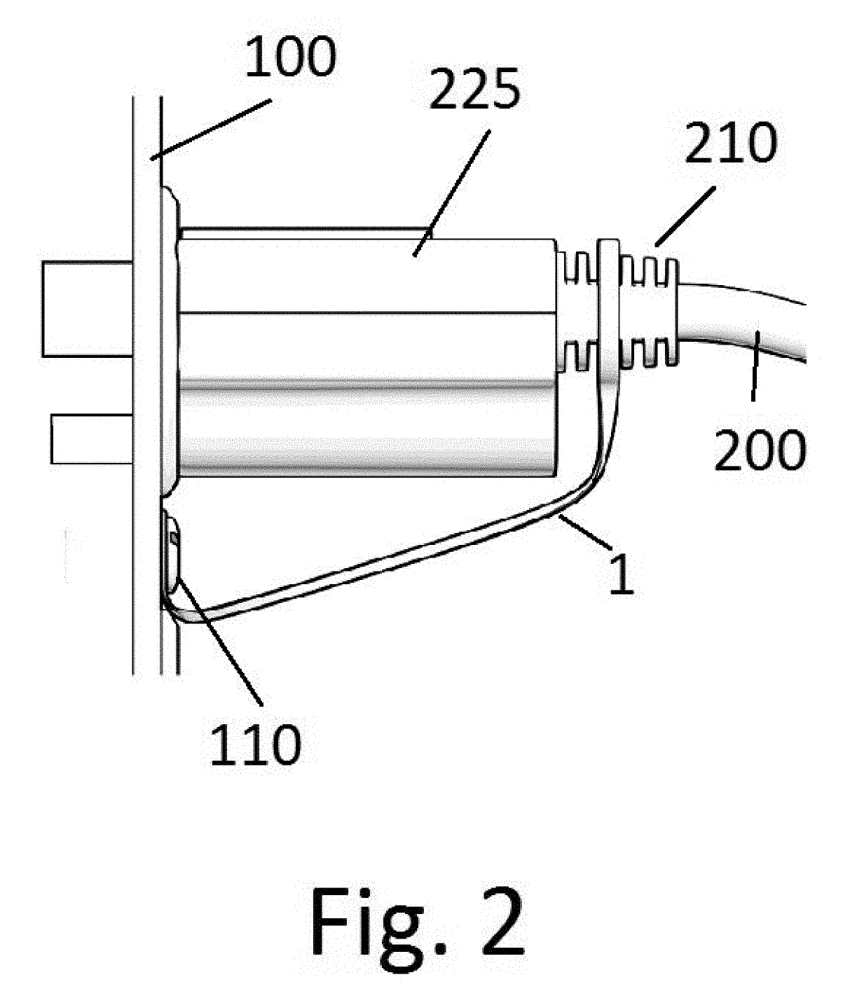

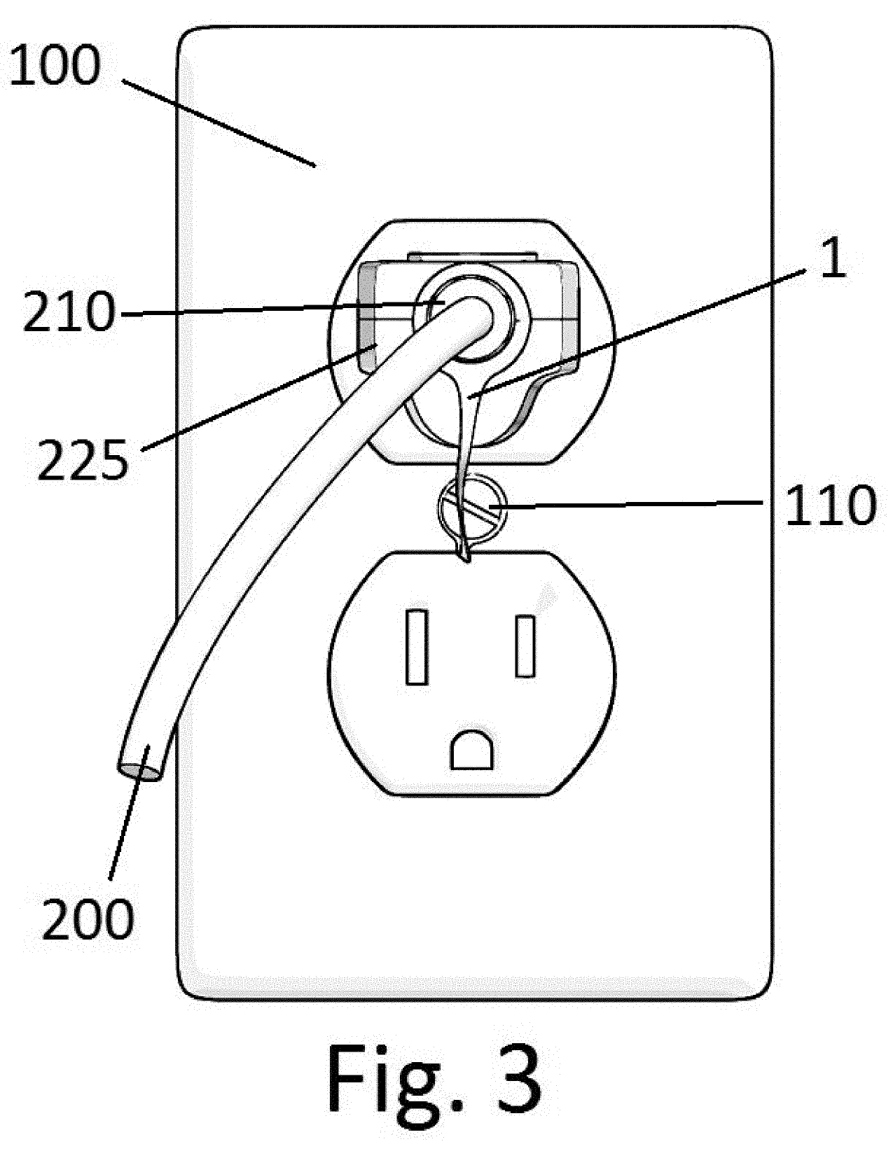

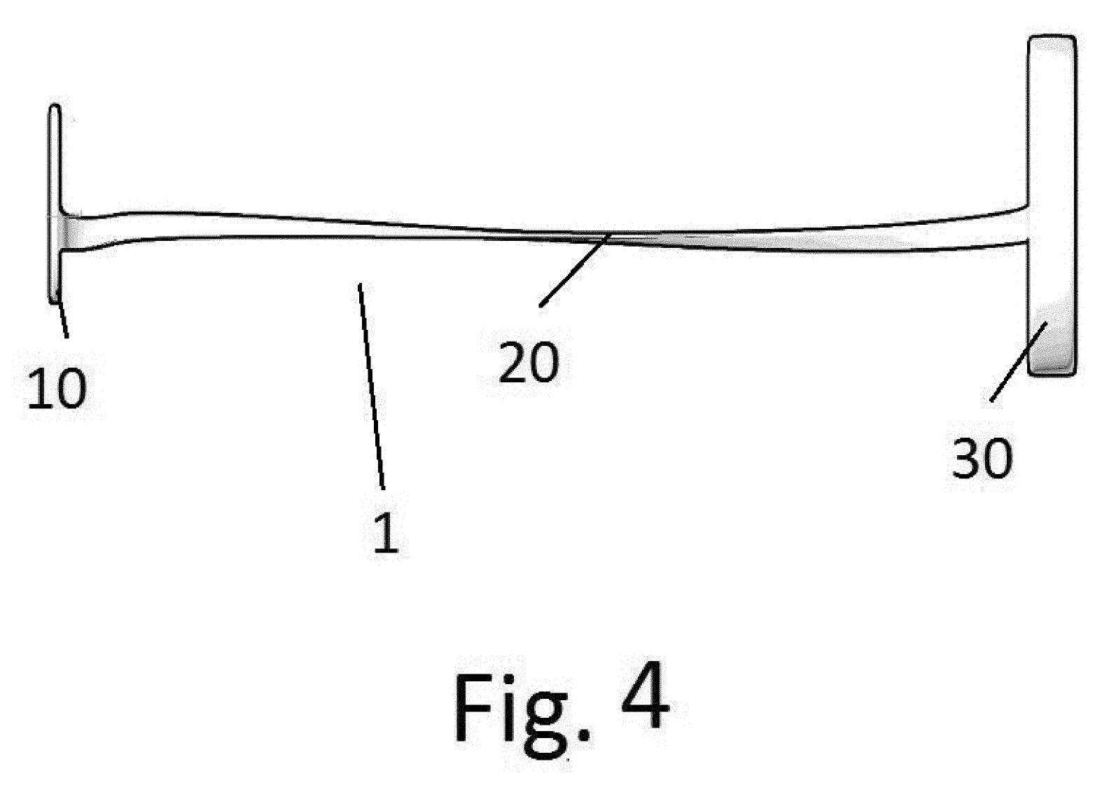

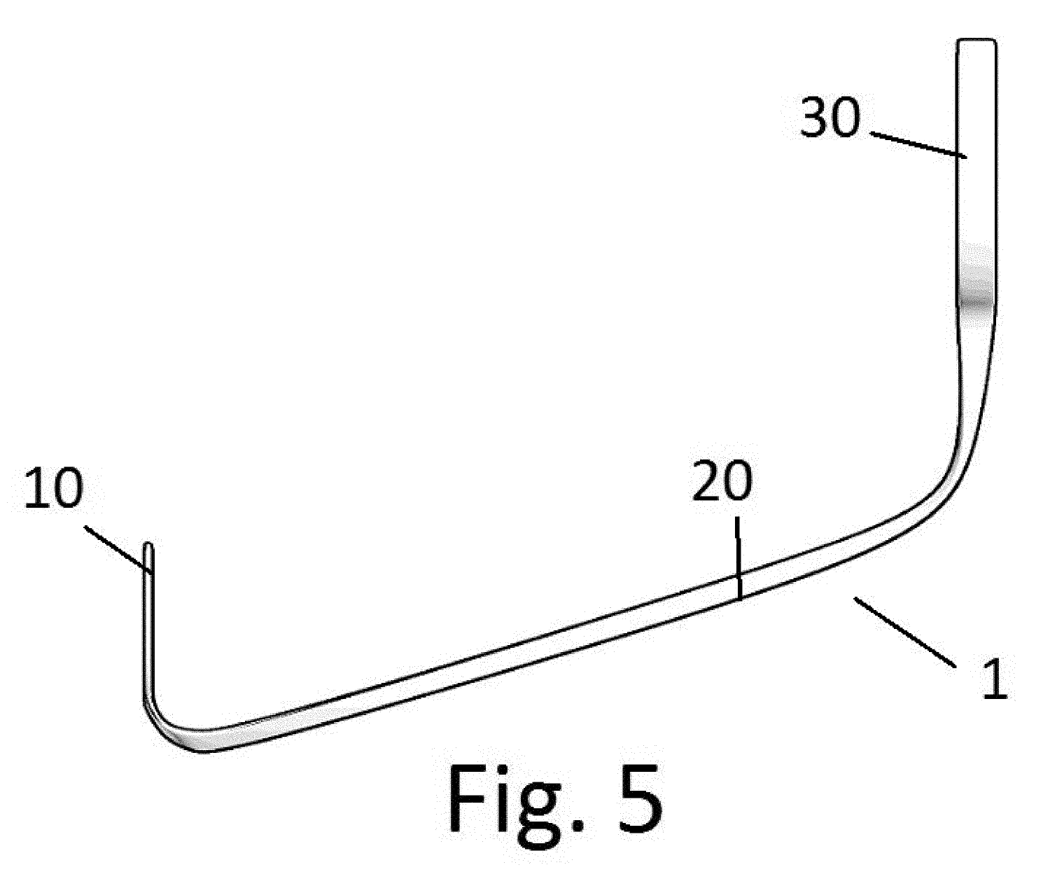

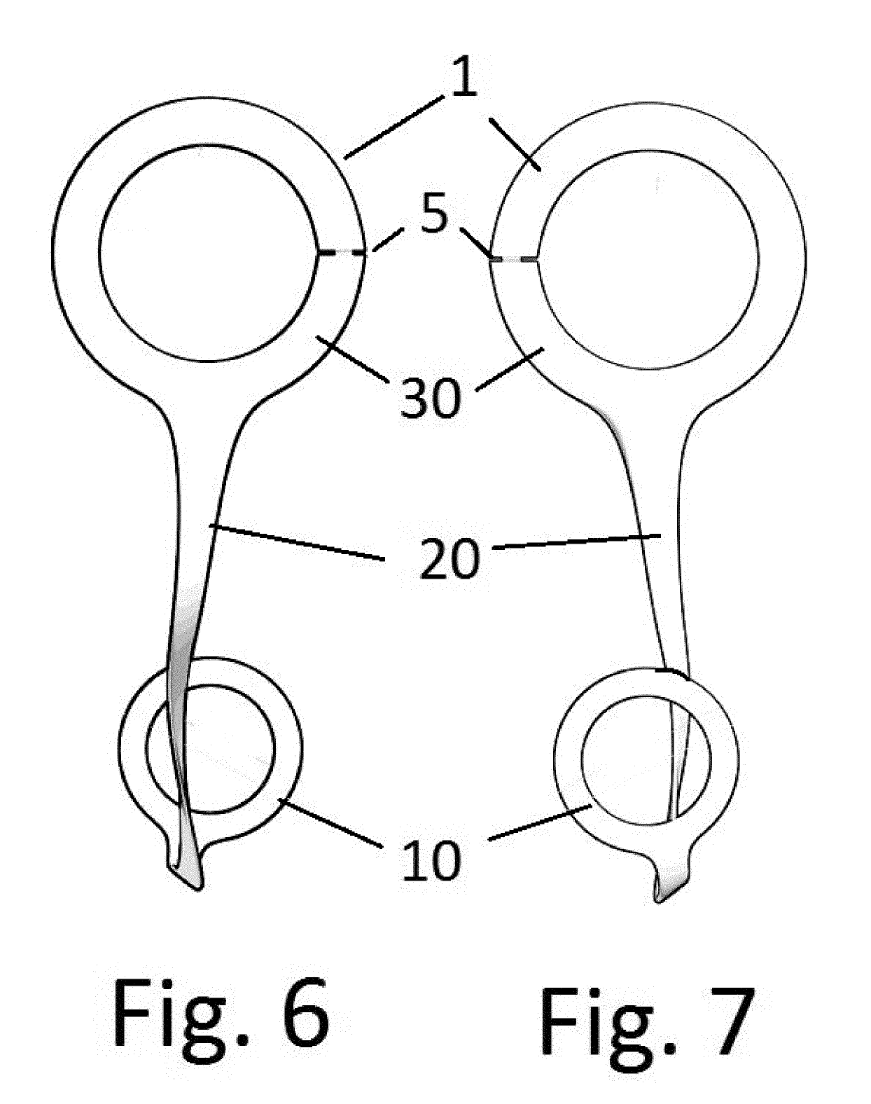

### DESCRIPTION OF THE PREFERRED EMBODIMENT

The current invention is a cord tether device 1 that would be a strong, flexible material that is used as a tether between an electric outlet wall plate and an electric cord 200.

The cord tether 1 would have two ends. One end would be the wall screw anchor 10 which is a circular formation with an opening in the center. This would secure the tether 1 to the electric outlet wall plate 100. The tether 1 would be secured by the screw 110 that holds the wall plate 100 to the wall. The screw 110 would go through the opening of the wall screw anchor 10. The circumference of the opening would be large enough for the screw body to go through but smaller than the diameter of the screw head. The screw 110 goes through the wall screw anchor opening and is then screwed into the wall as normal anchoring the tether 1.

The other end of the tether 1 is the cord anchor 30. This end of the tether would form a ring 30 with an opening in the middle. It would also have a break 5 in one side of the circular opening. The cord anchor 30 could be bent at the break 5 so that it snuggly fits around the base 210 of the plug 225 attached to the plug cord 200. The cord anchor 30 would be of a significant stiffness so that it would be difficult for a child to bend the plug cord 200 at the break 5. In another embodiment, the ends of the cord anchor 30 at the break would connect to each other using a connection means.

When an electric cord 200 is plugged in the outlet 100, the other end of the tether 1 would latch around the end 210 electric cord 200. This prevents young children from opening it.

The tether 1 would have a slim strip 20 that connects the cord anchor 30 end with the wall screw anchor 10. The strip 20 would be of a length that has too little slack to allow the electric cord to be unplugged, while the tether is secured on both ends. The strip 20 would be thinner than the anchors in the preferred embodiment.

There are a number of significant design features and improvements incorporated within the invention.

### Advantages

The innovative tether helps secure an electric cord to an outlet wall plate. This secures electrical cords from being accidently removed or being removed by young children. While plastic outlet inserts are commonly used to protect young children from outlets not-in-use, no easy option exists for preventing a child from removing an electrical cord from the outlet. While preventing child tampering, this tether is easily installed and uninstalled by a capable adult.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1-14. (canceled)

15. A device to anchor electrical cords comprising:
a tether with two end where one end it wall screw anchor and the other end is a plug anchor where the two anchors are connected by a strip, wherein the wall screw anchor has a hole in the center, a screw goes through the hole in the wall screw anchor and where said screw is screwed in, where the plug anchor has an opening with a break in it where the opening could be bent at the break so that it snuggly fits around a plug securing the plug into an electrical outlet.

16. A device according to claim 15 further comprising:
plug anchor comprising a stiffness structure.

17. A device according to claim 15 further comprising:
where the break would have ends that connect using a connection means.
